(19) United States
(12) Patent Application Publication
(10) Pub. No.: US 2007/0195961 A1
(43) Pub. Date: Aug. 23, 2007

(54) FM transmitter

(76) Inventor: Hirofumi Komori, Ukyo-Ku (JP)

Correspondence Address: CANTOR COLBURN, LLP, 55 GRIFFIN ROAD SOUTH, BLOOMFIELD, CT, 06002, US

(21) Appl. No.: 11/707,445

(22) Filed: Feb. 16, 2007

(30) Foreign Application Priority Data
Feb. 17, 2006 (JP) JP2006-040950

(51) Int. Cl. H04H 5/00

(52) U.S. Cl. 381/3; 381/16

(57) ABSTRACT

A stereo modulator converts an inputted audio signal to a stereo composite signal. A frequency modulator, which includes a PLL circuit, performs frequency modulation with the stereo composite signal outputted from the stereo modulator as being a modulation signal. A first programmable divider and a second programmable divider divide an external clock signal inputted from the outside by a first division ratio and a second division ratio set respectively and outputs. A first clock signal outputted from the first programmable divider is used as a reference clock signal for generating the stereo composite signal, and a second clock signal outputted from the second programmable divider is used as a reference clock signal of the PLL circuit.

### BACKGROUND OF THE INVENTION

1. Field of the Invention

The present invention relates to an FM transmitter that produces stereo composite signals and outputs them after performing frequency modulation thereon.

2. Description of the Related Art

There is a type of FM transmitter which converts audio signals to stereo composite signals and performs frequency modulation, using a frequency modulator, before outputting it. Such an FM transmitter is often used, for instance, to transfer the audio signals between a CD changer in a car audio system and a main head unit because such an FM transmitter can transfer the audio signals without the use of wiring such as an RCA cable. In recent years, small electronic equipment such as audio equipment having hard disks, memory audio equipment and mobile phone terminals having music playback functions has been finding wider use. And the FM transmitter is also used to play back music data, stored in such compact-size electronic equipment, from the speakers of the stationary audio components or the like.

When the FM transmitter is incorporated into a small-size electronic apparatus such as a mobile phone terminal, it is an important consideration to make the circuit thereof smaller. In the FM transmitter, the audio signal is converted to the stereo composite signal, the frequency modulation is performed using the stereo composite signals and then amplified before being transmitted from the antenna. The subcarriers of 38 kHz and the pilot signals of 19 kHz are used to produce the stereo composite signals. Further, if the frequency modulation is performed by a direct modulation using a PLL, a reference clock signal will be needed to determine the frequency of the subcarrier.

Related Art List

(1) Japanese Patent Application Laid-Open No. Hei09-069729.
(2) Japanese Patent Application Laid-Open No. Hei10-013370.

In order to generate these signals, in the conventional FM transmitter a crystal oscillator that oscillates at an integral multiple or preferably a common-factor multiple of the frequency (e.g., 200 kHz) of the reference clock of the PLL and the frequency (e.g., 19 kHz and 38 kHz) required to generate the stereo composite signal needs to be mounted for exclusive use in the FM transmitter. Nevertheless, the implementation area of the crystal oscillator is large and thus is costly. This contributes to preventing it to make the small electronic apparatus smaller and less costly. Also, it is difficult to share the oscillation frequency of the crystal oscillator required by the FM transmitter, with other blocks of the small electronic apparatus.

### SUMMARY OF THE INVENTION

The present invention has been made in view of the foregoing problems to be resolved, and a general purpose thereof is to provide an FM transmitter whose circuit scale is reduced.

An FM transmitter according to one embodiment of the present invention comprises: a stereo modulator which converts an inputted audio signal to a stereo composite signal; a frequency modulator, including a phase-locked loop (PLL) circuit therein, which performs frequency modulation with the stereo composite signal outputted from the stereo modulator as being a modulation signal; and a first programmable divider and a second programmable divider which divide an inputted external clock signal by a first division ratio and a second division ratio set respectively therefor and outputs it. An output signal of the first programmable divider is used as a reference clock signal for generating the stereo composite signal, and an output signal of the second programmable divider is used as a reference clock signal of the PLL circuit.

According to this embodiment, the reference clock signal used to generate the stereo composite signal and the reference clock signal of the PLL circuit are both generated from the same external clock signal, using the programmable dividers. As a result, there is no need to provide an exclusive-use oscillator and therefore the circuit scale can be reduced. Also, even in the case when the frequency of the external clock signal differs for each set mounted on the FM transmitter, the division ratios of the first programmable divider and the second programmable divider can be set independently. Hence, a desired reference clock required can be obtained.

The frequency of the reference clock signal of the PLL circuit may be set to a value at which a frequency necessary as a modulated signal outputted from the frequency modulator is obtained, and the frequency of the external clock signal may be set to an integral multiple of the frequency of the reference clock signal of the PLL circuit.

The reference clock signal of the PLL circuit, which affects the frequency of carriers of the FM transmitter, must be produced with accuracy. However, the required accuracy of the reference clock signal used to generate the stereo composite signal is not very high. Consequently, the relation between the frequency of the external clock signal and the reference clock signal of the PLL circuit is defined preferentially. Thereby, the performance of the entire FM transmitter can be raised.

An FM transmitter according to one embodiment may further comprise: a filter, provided before the stereo modulator, which corrects the band of the inputted audio signal and outputs it to the stereo modulator; and a third programmable divider which divides the external clock signal by a preset third division ratio. The filter may be configured as a switched-capacitor filter including a switching element, and an output signal of the third programmable divider may be used as a clock signal by which to switch on and off the switching element.

In this case, adding the third programmable divider allows the generation of a clock signal required by the switched-capacitor filter and therefore the circuitry can be simplified.

The external clock signal may be a system clock of a set mounted on the FM transmitter. By configuring the FM transmitter as described above, the division ratio of the first programmable divider and the division ratio of the second programmable divider can each be set independently. Hence, the frequency of the external clock signal will not be restricted to a particular value. Consequently, generating an internal clock of the FM transmitter based on the system clock of a set eliminates the oscillator for exclusive use in the FM transmitter, thus simplifying the set.

The FM transmitter may be integrated onto a single substrate. “Being integrated” includes a case where all of circuit components are formed on a semiconductor substrate or a case where the main components of a circuit are integrated thereon. Note that part of resistors or capacitors used to adjust circuit constants may be provided outside the semiconductor substrate. Integrating the FM transmitter into a single LSI can reduce the circuit area.

Another embodiment of the present invention relates to a small electronic apparatus. This small electronic apparatus comprises: an oscillator which generates a system clock of a predetermined frequency; an FM transmitter to which the system clock generated by the oscillator is inputted; and an antenna which transmits an output signal of the FM transmitter to the exterior.

According to this embodiment, simplifying the structure of the FM transmitter can make the whole equipment smaller and simplified.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a circuit diagram illustrating a structure of an FM transmitter according to a first embodiment of the present invention;

FIG. 2 is a block diagram showing internal structures of stereo modulator and frequency modulator in the FM transmitter shown in FIG. 1;

FIG. 3 is a block diagram showing a structure of an FM transmitter according to a second embodiment of the present invention; and

FIG. 4 is a block diagram showing a structure of a small-size electronic apparatus on which an FM transmitter according to an embodiment of the present invention is mounted.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

### First Embodiment

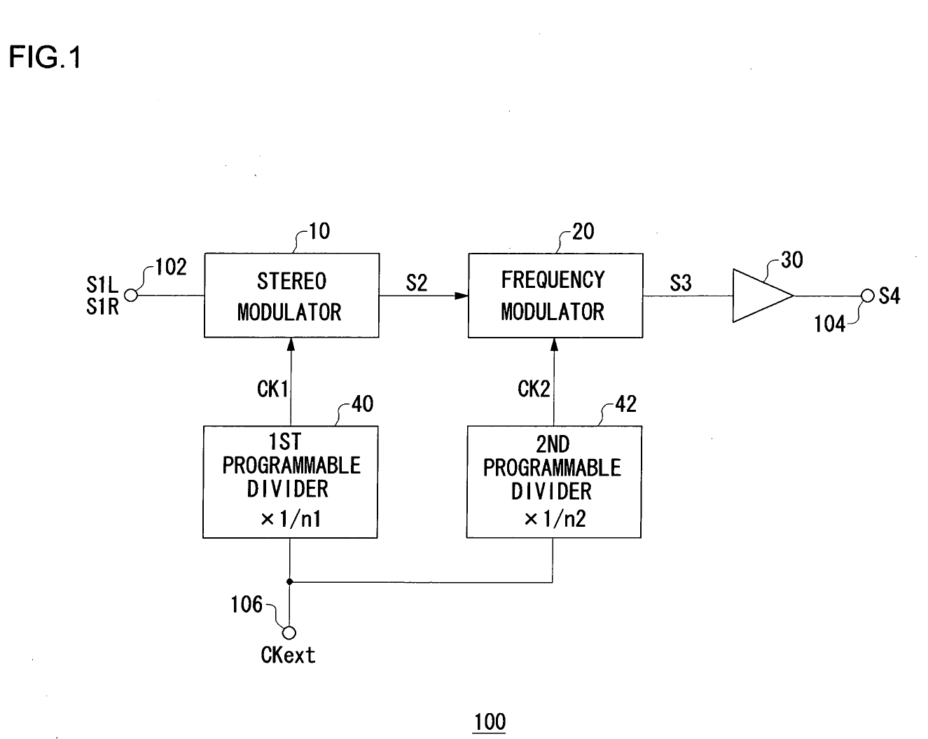

FIG. 1 is a circuit diagram illustrating a structure of an FM transmitter 100 according to a first embodiment of the present invention. The FM transmitter 100 converts stereo audio signals S1L and S1R composed of an L channel and an R channel inputted to an input terminal 102, to a stereo composite signal and performs frequency modulation thereon and then amplifies it so as to be outputted from an output terminal 104. The FM transmitter 100 is integrated onto a single semiconductor substrate as a function IC. The audio signal inputted to the input terminal 102 may be a monaural signal.

An overview of signal processing in the FM transmitter 100 will be first described. A stereo modulator 10 converts the inputted audio signals S1L and S1R to a stereo composite signal S2. A frequency modulator 20, which includes a PLL circuit as will be described later, performs frequency modulation with the stereo composite signal S2 as being a modulation signal. The frequency modulator 20 outputs a high-frequency signal S3 having a carrier frequency, to a power amplifier 30. The power amplifier 30 amplifies the inputted high-frequency signal S3 and then outputs the amplified signal from the output terminal 104.

An external clock signal CKext is inputted to a clock input terminal 106. It is desirable that a condition for the frequency for this external clock signal CKext be determined in advance as specifications for the FM transmitter. For example, in the FM transmitter according to an embodiment it is assumed that the frequency of the external clock signal CKext lies between 10 MHz to 20 MHz (inclusive) and is inputted as any of frequencies in this range in steps of Δf.

A first programmable divider 40 divides the external clock signal CKext inputted from the outside by a preset first division ratio n1 so as to be outputted to the stereo modulator 10. That is, the frequency f1 of the first clock signal CK1 inputted to the stereo modulator 10 is given by f1=fext/n1 using the frequency fext of the external clock signal CKext. A first clock signal CK1 outputted from the first programmable divider 40 is used as a reference clock signal by which to produce a stereo composite signal S2 in the stereo modulator 10. According to the first embodiment, the first division ratio n1 is so set that the frequency f1 of the first clock signal CK1 becomes closest to 38 kMHz.

A second programmable divider 42 divides the external clock signal CKext by a preset second division ratio n2 so as to be outputted to the frequency modulator 20. That is, the frequency f2 of a second clock signal CK2 inputted to the frequency modulator 20 is given by f2=fext/n2 using the frequency fext of the external clock signal CKext. The second clock signal CK2 outputted from the second programmable divider 42 is used as a reference clock signal of a PLL circuit in the frequency modulator 20.

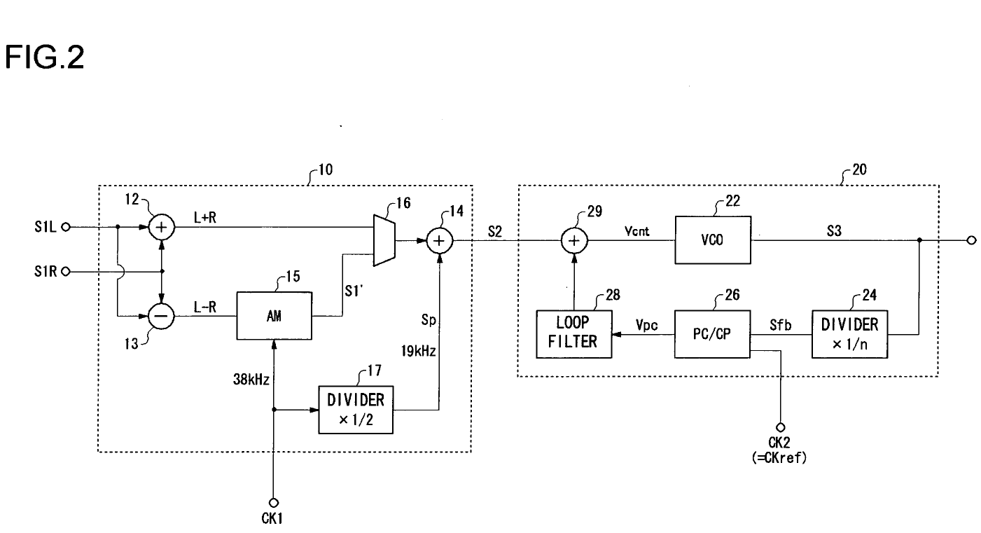

FIG. 2 is a block diagram showing internal structures of the stereo modulator 10 and the frequency modulator 20 in the FM transmitter 100 shown in FIG. 1. A brief description is first given of the structure and operation of the stereo modulator 10 and the frequency modulator 20, which are widely known already. In Figures from here on, components identical or similar to those already mentioned are given the same reference numerals and the explanation thereof will be omitted as appropriate.

The stereo modulator 10 includes an adder 12, a subtractor 13, an adder 14, an amplitude modulator 15, a multiplexer 16, and a ½ divider 17. The adder 12 adds up an L channel and an R channel of stereo audio signal so as to generate a sum signal L+R. The subtractor 13 generates a difference signal L−R from the L channel and the R channel of stereo audio signal. The amplitude modulator 15 performs amplitude modulation on the first clock signal CK1 of 38 kMHz outputted from the first programmable divider 40 shown in FIG. 1, using the difference signal L-R. The multiplexer 16 combines the sum signal L+R with a subcarrier S1′ outputted from the amplitude modulator 15. The ½ divider 17 divides the first clock signal CK1 of 38 kHz by 2 so as to produce a pilot signal Sp of 19 kHz. The adder 14 combines an output signal of the multiplexer 16 with the pilot signal Sp so as to generate the stereo composite signal S2.

The frequency modulator 20 includes a VCO 22, a divider 24, a phase comparator 26, a loop filter 28, and an adder 29.

The VCO 22 oscillates at a frequency that corresponds to a control voltage Vcnt. The output signal S3 of the VCO 22 is outputted to the exterior as a modulated signal and at the same time inputted to the divider 24. The divider 24 divides the frequency frf of the output signal S3 of the VCO 22 to 1/n (n being a natural number) and then outputs a feedback signal Sfb. The phase comparator 26 compares the feedback signal Sfb outputted from the divider 24 with a reference clock signal CKref and then outputs a voltage corresponding to the phase difference between the two signals (hereinafter this voltage will be referred to as phase difference voltage Vpc). As described above, the reference clock signal CKref of the PLL circuit is the second clock signal CK2 outputted from the second programmable divider 42.

The loop filter 28 removes high-frequency components of the phase difference voltage Vpc outputted from the phase comparator 26, so as to be outputted to the adder 29. The adder superimposes the stereo composite signal S2 outputted from the stereo modulator 10, with the output signal of the loop filter 28 and then outputs it as a control voltage Vcnt.

The output signal S3, whose carrier frequency frf is equal to CK2×n, is a frequency-modulated signal by the stereo composite signal S2.

Here, the frequency of the reference clock signal CKref(=CK2) of the PLL circuit is set to a value by which a frequency required as the modulated signal S3 outputted from the frequency modulator 20 is obtained. That is, if the frequency of a carrier is varied in steps of 100 kHz, the frequency of the reference clock signal CKref will be set to 100 kHz or its divisor. Suppose that a configuration is implemented such that a ½ divider is further provided subsequent to the frequency modulator 20 and the output signal S3 is divided by 2 and is then outputted to a subsequent block. Then the reference clock signal CKref will be set to 200 kHz or its divisor. Moreover, it is desirable that the frequency fext of the external clock signal CKext be set to an integral multiple of the frequency f2 of the reference clock signal CKref in the PLL circuit.

According to the FM transmitter 100 configured as above, the reference clock signal CK1 used to generate the stereo composite signal S2 and the reference clock signal CK2(=CKref) of the PLL circuit are generated from the same external clock signal CKext, using the programmable dividers. As a result, there is no need to provide an exclusive-use oscillator and therefore the circuit scale can be reduced. Also, even in the case when the frequency of the external clock signal CKext differs for each set mounted on the FM transmitter, the division ratios n1 and n2 of the first programmable divider 40 and the second programmable divider 42 can be set independently. Hence, a desired reference clock required by the stereo modulator 10 and the frequency modulator 20 can be obtained.

The reference clock signal CKref(=CK2) of the PLL circuit, which affects the frequency of carriers of the FM transmitter 100, must be produced with accuracy. In contrast thereto, the required accuracy of the reference clock signal CK1 used to generate the stereo composite signal is not very high. In the light of this, the relation between the frequency of the external clock signal CKext and the reference clock signal CKref(=CK2) of the PLL circuit is defined in preference to the relation between the external clock signal CKext and the first clock signal CK1. Thereby, the performance of the entire FM transmitter can be enhanced.

### Second Embodiment

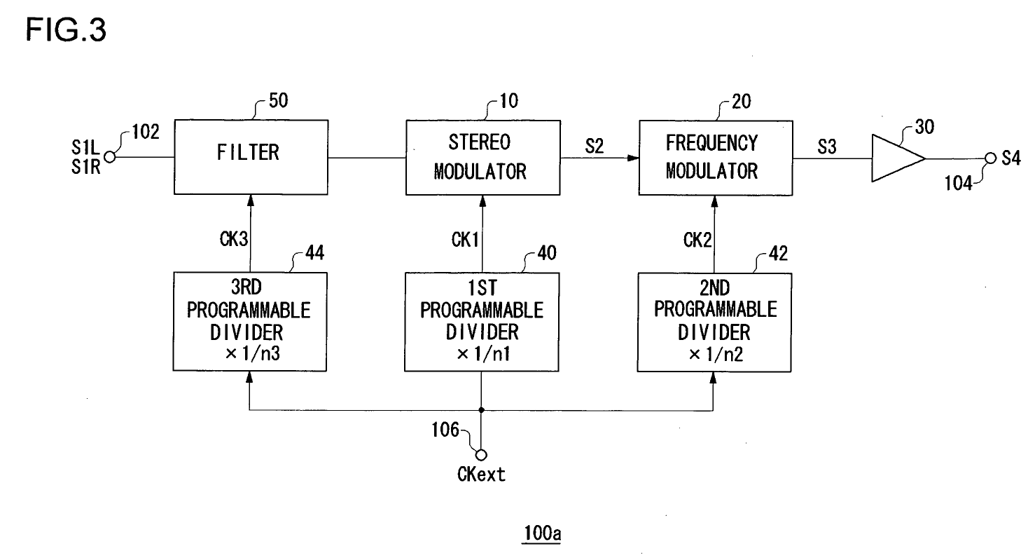

According to a second embodiment, a filter provided before the stereo modulator 10 is configured in the FM transmitter 100 by using a switched capacitor. FIG. 3 is a block diagram showing a structure of the FM transmitter 100a according to the second embodiment of the present invention. A description will be given hereinbelow centering around differences from the first embodiment.

In addition to the components shown in FIG. 1, the FM transmitter 100a further comprises a filter 50 and a third programmable divider 44. The filter 50, which is provided before the stereo modulator 10, corrects the band of the inputted stereo audio signal S1L and S1R so as to be outputted to the stereo modulator 10. The filter is a low-pass filter, preemphasis filter or the like, for example. In the second embodiment, at least part of these filters is configured as a switched-capacitor filter using capacitors and switching elements.

The third programmable divider 44 divides an external block signal CKext by a preset third division ratio n3 so as to be supplied to the filter 50. A third clock signal CK3 outputted from the third programmable divider 44 is used as a clock signal for turning on and off a switching element inside the filter 50.

The frequency response of a switched-capacitor filter depends on the switching frequency of the switching element inside the filter 50. Consequently, the clock signal supplied to the switching element is produced using the third programmable divider 44 capable of adjusting the division ratio, based on the external clock signal CKext. Hence, the circuit can be configured without adding another oscillator. Further, even if the frequency of the external clock signal CKext varies, the frequency response of the filter 50 can be set to a desired property by setting the third division ratio n3 of the third programmable divider 44 to an appropriate value.

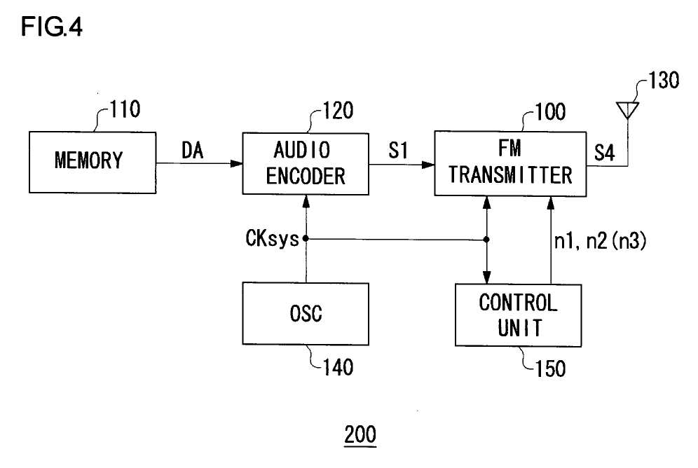

A description has been given of a structure and an operation of the FM transmitter, based on the present embodiments. Next, a description will be given of applications to the FM transmitter according to the present embodiments. For example, the above-described FM transmitter 100 can be preferably mounted on a small-size electronic apparatus such as a mobile phone terminal having an audio playback function. FIG. 4 is a block diagram showing a structure of a small-size electronic apparatus on which an FM transmitter according to an embodiment of the present invention is mounted.

A small-size electronic apparatus 200 is comprised of an FM transmitter 100, a memory 110, an audio encoder 120, an antenna 130, an oscillator 140, and a control unit 150.

The oscillator 140 has a predetermined oscillation frequency and generates a system clock CKsys of the small-size electronic apparatus 200. In the memory 110, audio data are recorded in a compressed or uncompressed form. The audio encoder 120 reads out audio data DA from the memory 110 and encodes them as necessary so as to generate audio signals S1L and S1R, and then outputs them to the FM transmitter 100. As described above, the FM transmitter 100 performs stereo modulation and frequency modulation and then outputs an amplified high-frequency signal S4 to the antenna 130.

The audio encoder 120 and the control unit 150 perform a predetermined arithmetic processing by the system clock signal CKsys. This system clock signal CKsys is inputted to the FM transmitter 100 as the external clock signal CKext.

The control unit 150 is, for example, a microprocessor and sets the division ratios n1, n2 and the like of the first programmable divider 40, the second programmable divider 42 and the like according to the oscillation frequency of the oscillator 140, namely the frequency of the system clock CKsys. The setting of division ratios can be realized in a manner that registers and the like are provided in the FM transmitter 100 and the values thereof are changeable from the outside.

According to the compact-size electronic apparatus 200 shown in FIG. 4, the system clock CKsys is used as an external clock signal of the FM transmitter 100 and also used as a clock signal of other circuit blocks. Thus, a single oscillator suffices for the operation. That is, there is no need of providing a costly crystal oscillator and the like for exclusive use in the FM transmitter, so that the set can be made small and the low cost can be realized. Also, even in the case when the FM transmitter 100 is mounted on a set where the frequency of the system clock signal differs, the stable stereo modulation and frequency modulation can be achieved by appropriately setting the division ratios n1 and n2 of the first programmable divider 40, the second programmable divider 42 and the like. That is, the FM transmitter 100 is not restricted by the system clock of a set on which the FM transmitter 100 is mounted, and there is also another advantageous aspect in that the flexibility of the FM transmitter 100 is higher than that of the conventional FM transmitters.

While the preferred embodiments of the present invention have been described using specific terms, such description is for illustrative purposes only, and it is to be understood that changes and variations may be further made without departing from the spirit or scope of the appended claims.

What is claimed is:

1. An FM transmitter, comprising:
a stereo modulator which converts an inputted audio signal to a stereo composite signal;
a frequency modulator, including a phase-locked loop (PLL) circuit therein, which performs frequency modulation with the stereo composite signal outputted from said stereo modulator as being a modulation signal; and
a first programmable divider and a second programmable divider which divide an inputted external clock signal by a first division ratio and a second division ratio set respectively therefor and outputs it,
wherein an output signal of said first programmable divider is used as a reference clock signal for generating the stereo composite signal, and an output signal of said second programmable divider is used as a reference clock signal of the PLL circuit.

2. An FM transmitter according to claim 1, wherein the frequency of the reference clock signal of the PLL circuit is set to a value at which a frequency necessary as a modulated signal outputted from said frequency modulator is obtained, and
the frequency of the external clock signal is set to an integral multiple of the frequency of the reference clock signal of the PLL circuit.

3. An FM transmitter according to claim 1, further comprising:
a filter, provided before said stereo modulator, which corrects the band of the inputted audio signal and outputs it to said stereo modulator; and
a third programmable divider which divides the external clock signal by a preset third division ratio,
wherein said filter is configured as a switched-capacitor filter including a switching element, and an output signal of said third programmable divider is used as a clock signal by which to switch on and off the switching element.

4. An FM transmitter according to claim 2, further comprising:
a filter, provided before said stereo modulator, which corrects the band of the inputted audio signal and outputs it to said stereo modulator; and
a third programmable divider which divides the external clock signal by a preset third division ratio,
wherein said filter is configured as a switched-capacitor filter including a switching element, and an output signal of said third programmable divider is used as a clock signal by which to switch on and off the switching element.

5. An FM transmitter according to claim 1, wherein the external clock signal is a system clock of a set mounted on said FM transmitter.

6. An FM transmitter according to claim 1, wherein said FM transmitter is integrated onto a single substrate.

7. A small electronic apparatus, comprising:
an oscillator which generates a system clock of a predetermined frequency;
an FM transmitter to which the system clock generated by said oscillator is inputted; and
an antenna which transmits an output signal of said FM transmitter,
said FM transmitter including:
a stereo modulator which converts an inputted audio signal to a stereo composite signal;
a frequency modulator, including a phase-locked loop (PLL) circuit therein, which performs frequency modulation with the stereo composite signal outputted from the stereo modulator as being a modulation signal; and
a first programmable divider and a second programmable divider which divide the inputted system clock signal by a first division ratio and a second division ratio set respectively therefor and outputs it;
wherein an output signal of the first programmable divider is used as a reference clock signal for generating the stereo composite signal, and an output signal of the second programmable divider is used as a reference clock signal of the PLL circuit.
